(19) United States
(12) Patent Application Publication
(10) Pub. No.: US 2015/0287426 A1
(43) Pub. Date: Oct. 8, 2015

(54) MAGNETIC READ HEAD HAVING SPIN HALL EFFECT LAYER

(71) Applicant: HGST NETHERLANDS B.V., Amsterdam (NL)

(72) Inventors: Goran MIHAJLOVIC, San Jose, CA (US); Petrus VAN DER HEIJDEN, Cupertino, CA (US)

(73) Assignee: HGST NETHERLANDS B.V., Amsterdam (NL)

(21) Appl. No.: 14/246,985

(22) Filed: Apr. 7, 2014

(51) Int. Cl. G11B 5/37; G11B 5/31

(52) U.S. Cl. CPC G11B 5/37; G11B 5/3143

(57) ABSTRACT

The embodiments disclosed generally relate to a read head in a magnetic recording head. The read head utilizes a spin Hall effect layer disposed on the free magnetic layer. Electrical bias is applied to the top shield, or lead layer, longitudinally so that the current is longitudinally driven through the spin Hall effect layer. The spin Hall effect layer may comprise Pt, Ta, W, copper doped with either bismuth or iridium, a noble metal having group 5d non-magnetic impurities, or combinations thereof. The spin Hall effect layer, together with the longitudinally applied bias, reduces the damping in the free magnetic layer and hence, reduces the thermal magnetic noise of the read head.

### BACKGROUND OF THE INVENTION

1. Field of the Invention

Embodiments disclosed herein generally relate to a magnetic read head for use in a hard disk drive.

2. Description of the Related Art

The heart of a computer is a magnetic disk drive which typically includes a rotating magnetic disk, a slider that has read and write heads, suspension arms above and below the rotating disk and an actuator arm that swings the suspension arm to place the read and/or write heads over selected circular tracks on the rotating disk. The suspension arm biases the slider towards the surface of the disk when the disk is not rotating but, when the disk rotates, air is swirled by the rotating disk adjacent a media facing surface (MFS), such as an air bearing surface (ABS), of the slider causing the slider to ride on an air bearing a slight distance from the surface of the rotating disk. When the slider rides on the air bearing, the write and read heads are employed for writing magnetic transitions corresponding to host data. The read and write heads are connected to a signal processing circuitry that operates according to a computer program to implement the writing and reading functions.

The major limiting factor for achieving the required signal to noise ratio (SNR) for magnetoresistive heads, either tunnel magnetoresistive (TMR) heads or current perpendicular to plane-giant magnetoresistive (CPP-GMR) heads, for applications above 1 Tb/in² is thermal magnetic noise of the free magnetic layer. The thermal magnetic noise is inversely proportional to the device volume and therefore, the noise becomes a bigger problem as the free magnetic layer volume continues to shrink. The noise is also proportional to the bias current applied through the device and the magnetoresistive ratio of the device, thus, unlike thermal electronic noise (i.e., Johnson noise), thermal magnetic noise cannot be overcome by increasing the bias current or the device magnetoresistive ratio.

Physically, the most effective way to tune the magnetic noise is via a damping parameter of the free magnetic layer because the noise power is directly proportional to the damping parameter of the free magnetic layer and the signal is not affected by changes in damping. Currently, there are no known efficient ways to tune the magnetic noise by exploiting this mechanism.

Therefore, there is a need in the art for a magnetic read head with a tuned damping parameter of the free magnetic layer.

### SUMMARY OF THE INVENTION

The embodiments disclosed generally relate to a read head in a magnetic recording head. The read head utilizes a spin Hall effect layer disposed over the free magnetic layer. Electrical bias is applied to the top shield, or lead layer, longitudinally so that the current is longitudinally driven through the spin Hall effect layer. The spin Hall effect layer may comprise Pt, Ta, W, or copper doped with either bismuth or iridium, or combinations thereof. The spin Hall effect layer, together with the longitudinally applied bias, reduces the damping in the free magnetic layer and hence, reduces the thermal magnetic noise of the read head.

In one embodiment, a magnetic read head comprises a magnetic sensor having a free magnetic layer; and a spin Hall effect layer disposed over the free magnetic layer, wherein the spin Hall effect layer reduces damping in the free magnetic layer and thermal magnetic noise of the read head.

In another embodiment, a magnetic read head comprises: a bottom shield; a pinned magnetic structure disposed over the bottom shield; a spacer layer disposed on the pinned magnetic structure; a free magnetic layer disposed on the spacer layer; a spin Hall effect layer disposed on the free magnetic layer; a first insulating layer disposed on the bottom shield, sidewalls of the pinned magnetic structure, sidewalls of the spacer layer, sidewalls of the free magnetic layer, and sidewalls of the spin Hall effect layer; a hard bias layer disposed on the first insulating layer, wherein the hard bias layer has a top surface that is collinear with a top surface of thee free magnetic layer; a second insulating layer disposed on the hard bias layer, wherein the second insulating layer has a top surface that is collinear with a top surface of the spin Hall effect layer; and a top shield disposed on the second insulating layer and the spin Hall effect layer, wherein the top shield is electrically coupled to a power source.

In another embodiment, a magnetic read head comprises: a bottom shield; a pinned magnetic structure disposed over the bottom shield; a spacer layer disposed on the pinned magnetic structure; a free magnetic layer disposed on the spacer layer; a spin Hall effect layer disposed on the free magnetic layer; a first insulating layer disposed on the bottom shield, sidewalls of the pinned magnetic structure, sidewalls of the spacer layer, sidewalls of the free magnetic layer, and sidewalls of the spin Hall effect layer; a hard bias layer disposed on the first insulating layer, wherein the hard bias layer has a top surface that is collinear with a top surface of thee free magnetic layer; a second insulating layer disposed on the hard bias layer, wherein the second insulating layer is thinner than the spin Hall effect layer; and a top shield disposed on the second insulating layer and the spin Hall effect layer, wherein the top shield is electrically coupled to a power source.

In another embodiment, a magnetic read head comprises: a bottom shield; a pinned magnetic structure disposed over the bottom shield; a spacer layer disposed on the pinned magnetic structure; a free magnetic layer disposed on the spacer layer; a spin Hall effect spacer layer disposed on the free magnetic layer; a spin Hall effect layer disposed on the spin Hall effect spacer layer; a first insulating layer disposed on the bottom shield, sidewalls of the pinned magnetic structure, sidewalls of the spacer layer, sidewalls of the free magnetic layer, and sidewalls of the spin Hall effect layer; a hard bias layer disposed on the first insulating layer, wherein the hard bias layer has a top surface that is collinear with a top surface of thee free magnetic layer; a second insulating layer disposed on the hard bias layer, wherein the second insulating layer is thinner than the spin Hall effect layer; and a top shield disposed on the second insulating layer and the spin Hall effect layer, wherein the top shield is electrically coupled to a power source.

In another embodiment, magnetic read head comprises: a bottom shield; a pinned magnetic structure disposed over the bottom shield; a spacer layer disposed on the pinned magnetic structure; a free magnetic layer disposed on the spacer layer; a spin Hall effect layer disposed on the free magnetic layer; a first insulating layer disposed on the bottom shield, sidewalls of the pinned magnetic structure, sidewalls of the spacer layer, sidewalls of the free magnetic layer, and sidewalls of the spin Hall effect layer; a hard bias layer disposed on the first insulating layer, wherein the hard bias layer has a top surface that is collinear with a top surface of thee free magnetic layer; a second insulating layer disposed on the hard bias layer, wherein the second insulating layer is thinner than the spin Hall effect layer; a laminated shield consisting of a first shield layer disposed on the second insulating layer and the spin Hall effect layer, wherein the first shield layer is electrically coupled to a power source; a third insulating layer that can propagate interlayer exchange coupling disposed on the first shield layer; and a top shield disposed on the third insulating layer.

In another embodiment, a magnetic read head comprises: a bottom shield; a pinned magnetic structure disposed over the bottom shield; a spacer layer disposed on the pinned magnetic structure; a free magnetic layer disposed on the spacer layer; a spin Hall effect layer disposed on the free magnetic layer; a first insulating layer disposed on the bottom shield, sidewalls of the pinned magnetic structure, sidewalls of the spacer layer, sidewalls of the free magnetic layer, and sidewalls of the spin Hall effect layer; a side shield disposed on the first insulating layer and the spin Hall effect layer, wherein the side shield is electrically coupled to a power source; a second insulating layer that can propagate interlayer exchange coupling disposed on the side shield; and a top shield disposed on the second insulating layer.

The magnetic read heads discussed herein may be used in various types of magnetic storage mediums such as hard disk drives, tape magnetic storage and hybrid drives which include a mixture of magnetic disk media and flash memory.

### BRIEF DESCRIPTION OF THE DRAWINGS

So that the manner in which the above recited features can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary magnetic disk drive, according to an embodiment of the invention.

FIG. 2 is a side view of a read/write head and magnetic disk of the disk drive of FIG. 1, according to one embodiment of the invention.

FIGS. 3A-3E are schematic illustrations of read heads according to embodiments of the invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The embodiments disclosed generally relate to a read head in a magnetic recording head. The read head utilizes a spin Hall effect layer disposed on the free magnetic layer. Electrical bias is applied to the top shield, or lead layer, longitudinally so that the current is longitudinally driven through the spin Hall effect layer. The spin Hall effect layer may comprise Pt, Ta, W, or copper doped with either bismuth or iridium, or combinations thereof. The spin Hall effect layer, together with the longitudinally applied bias, reduces the damping in the free magnetic layer and hence, reduces the thermal magnetic noise of the read head.

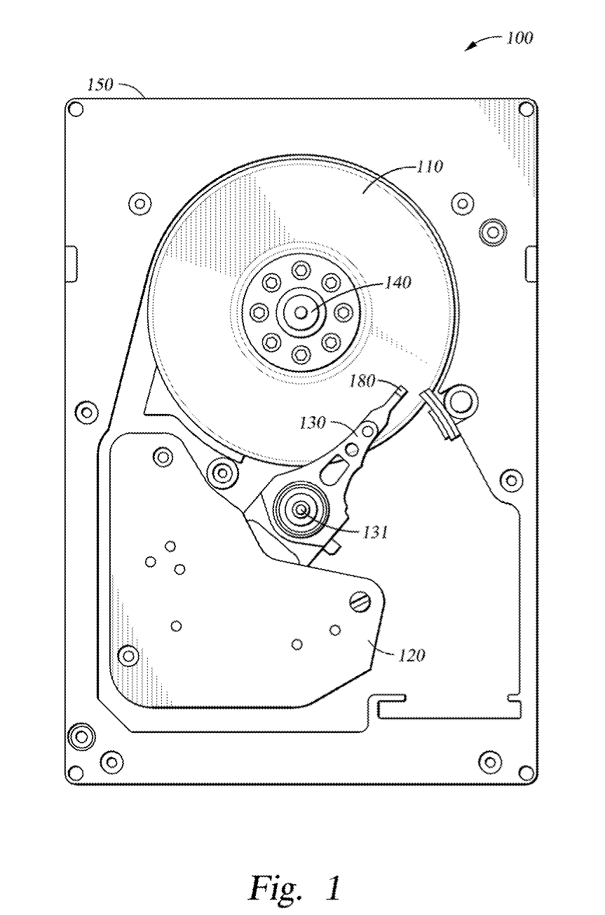

FIG. 1 illustrates a top view of an exemplary hard disk drive (HDD) 100, according to an embodiment of the invention. As illustrated, HDD 100 may include one or more magnetic disks 110, actuator 120, actuator arms 130 associated with each of the magnetic disks 110, and spindle motor 140 affixed in a chassis 150. The one or more magnetic disks 110 may be arranged vertically as illustrated in FIG. 1. Moreover, the one or more magnetic disks 110 may be coupled with the spindle motor 140.

Magnetic disks 110 may include circular tracks of data on both the top and bottom surfaces of the disk. A magnetic head 180 mounted on a slider may be positioned on a track. As each disk spins, data may be written on and/or read from the data track. Magnetic head 180 may be coupled to an actuator arm 130 as illustrated in FIG. 1. Actuator arm 130 may be configured to swivel around actuator axis 131 to place magnetic head 180 on a particular data track.

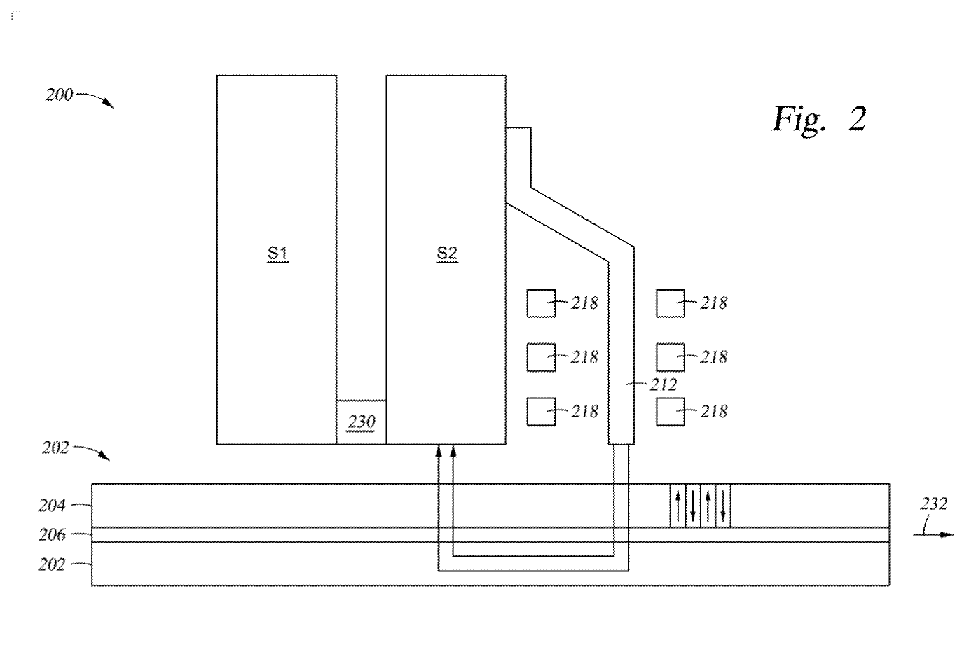

FIG. 2 is a fragmented, cross-sectional side view through the center of a read/write head 200 facing magnetic disk 202. The read/write head 200 and magnetic disk 202 may correspond to the magnetic head 180 and magnetic disk 110, respectively in FIG. 1. In some embodiments, the magnetic disk 202 may be a “dual-layer” medium that includes a perpendicular magnetic data recording layer (RL) 204 on a “soft” or relatively low coercivity magnetically permeable underlayer (PL) 206. The read/write head 200 includes a MFS, such as an ABS, a magnetic write head and a magnetic read head, and is mounted such that its MFS or ABS is facing the magnetic disk 202. In FIG. 2A, the disk 202 moves past the head 200 in the direction indicated by the arrow 232. The RL 204 is illustrated with perpendicularly recorded or magnetized regions, with adjacent regions having magnetization directions, as represented by the arrows located in the RL 204. The magnetic fields of the adjacent magnetized regions are detectable by the sensing element 230 as the recorded bits. The write head includes a magnetic circuit made up of a main pole 212 and a thin film coil 218 shown in the section embedded in non-magnetic material 219.

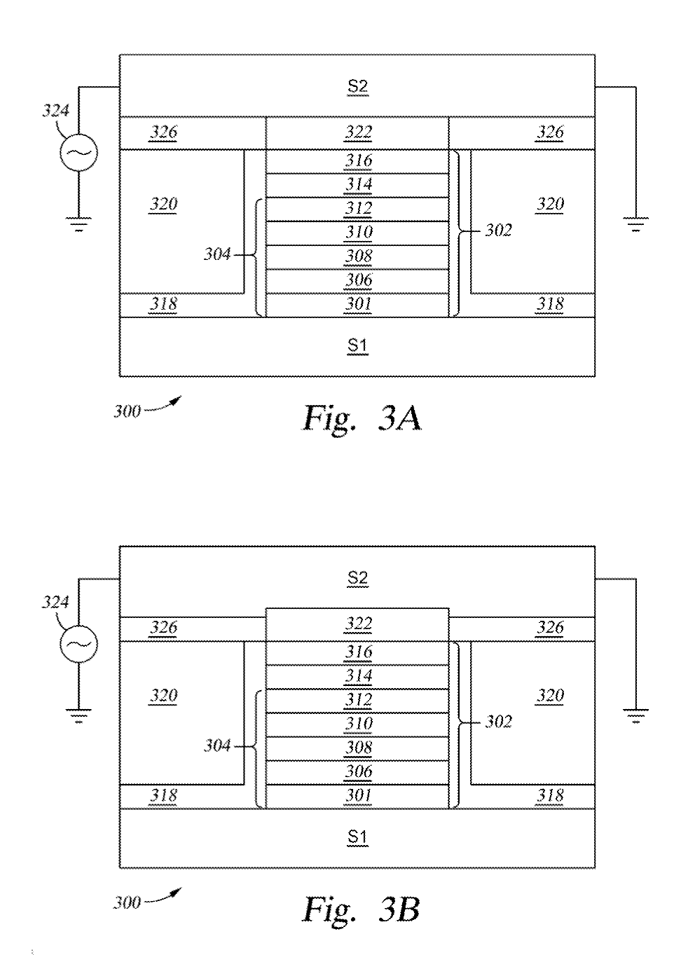

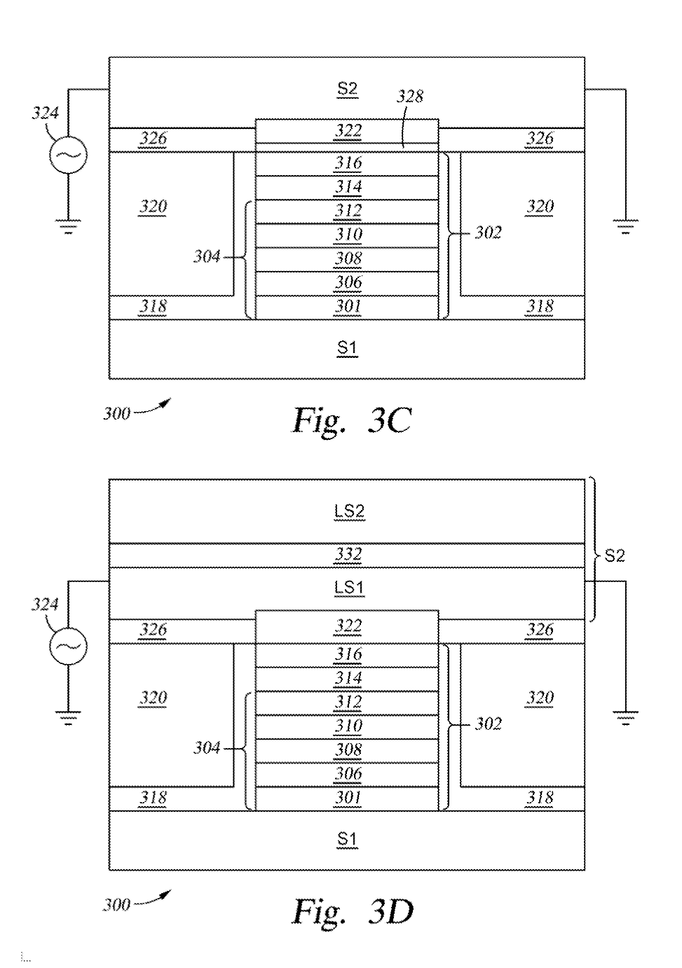

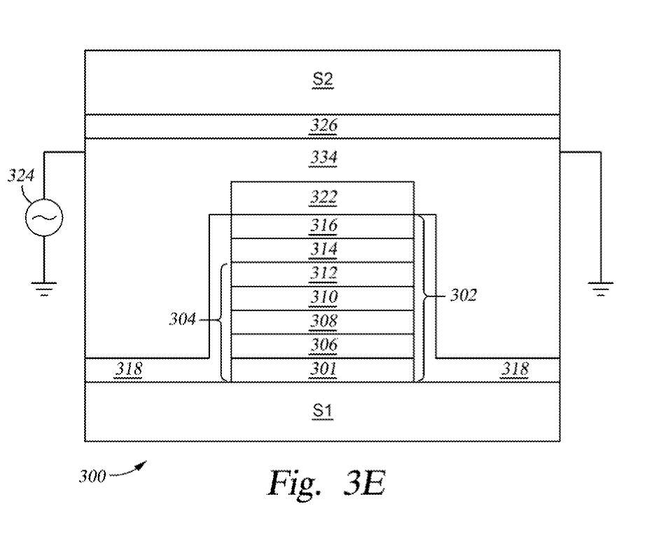

FIGS. 3A-3E are schematic illustrations of read heads according to embodiments of the invention. The read heads generally include a sensor having a free layer. A spin Hall effect layer is disposed over the free magnetic layer. Insulating material may border the sensor with either hard or soft bias material thereon. Alternatively, a side shield may be present.

FIG. 3A shows a read head 300 according to one embodiment. The read head 300 includes a bottom shield S1. The bottom shield S1 may comprise a ferromagnetic material such as Ni, Fe, Co, NiFe, NiFeCo, NiCo, CoFe and combinations thereof. A sensor structure 302 is disposed on the bottom shield S1. The sensor structure 302 includes a pinned magnetic structure 304. The pinned magnetic structure 304 may comprise a single pinned magnetic layer comprising a ferromagnetic layer. In the embodiment shown in FIGS. 3A-3E, the pinned magnetic structure 304 is decoupled from the bottom shield S1 by a nonmagnetic seed layer 301. The nonmagnetic seed layer 301 may comprise tantalum, ruthenium, or combinations thereof. The pinned magnetic structure 304 comprises an antiferromagnetic layer 306 disposed on the nonmagnetic seed layer 301. The antiferromagnetic layer 306 may comprise Pt, Ir, Rh, Ni, Fe, Mn, or combinations thereof such as PtMn, PtPdMn, NiMn or IrMn. The antiferromagnetic layer 306 has a thickness of about 60 Angstroms.

A pinned magnetic layer 308 is deposited on the antiferromagnetic layer 306. The pinned magnetic layer 308 may comprise one or more magnetic materials such as, for example, NiFe, CoFe, CoFeB, or diluted magnetic alloys. A nonmagnetic coupling layer 310 is deposited on the pinned magnetic layer 308. The coupling layer 310 may comprise Ru, Ta or combinations thereof. A reference magnetic layer 312 is deposited on the nonmagnetic coupling layer 310. The reference magnetic layer 312 may comprise one or more magnetic materials such as, for example NiFe, CoFe, CoFeB, or diluted magnetic alloys. A spacer layer 314 is deposited on the reference magnetic layer 312. In the case of a TMR sensor, the spacer layer 314 comprises an insulating material such as MgO, TiO₂ or alumina. For a GMR sensor, the spacer layer 314 may comprise a conductive material such as Cu, Ag, or their alloys with other metals. Each of the layers of the sensor structure 302 may be deposited by well known deposition methods such as sputtering.

A free magnetic layer 316 is deposited on the spacer layer 314. The free magnetic layer 316 may comprise Co, Fe, B, Co, CoFe, CoFeB, NiFe, CoHf or combinations thereof. The free magnetic layer 316 may comprise a single layer of magnetic material or, in other embodiments, multiple layers. The free magnetic layer 316 has a thickness of between about 15 Angstroms to about 75 Angstroms. While not shown, a capping layer may be disposed on the free magnetic layer 316. The capping layer would have a thickness of between about 15 Angstroms and about 75 Angstroms. In some embodiments, the capping layer may comprise multiple layers.

Bordering the sensor structure 302 is a first insulating layer 318 that is disposed on the first shield layer S1 as well as the sidewalls of the sensor structure 302, such as the pinned magnetic structure 304, the spacer layer 314 and the free magnetic layer 316. The first insulating layer 318 may comprise an insulating material such as aluminum oxide or silicon nitride. The first insulating layer 318 may be deposited by well known deposition methods such as atomic layer deposition (ALD), chemical vapor deposition (CVD), and ion beam sputtering (IBD). On the first insulating layer 318, a magnetic bias layer 320 is then deposited. The bias layer 320 may comprise a single material or laminated magnetic materials such as CoPt, FePt, high moment CoFe or NiFe. Once the bias layer 320 is deposited, a bias capping structure, not shown, may be deposited over the bias layer 320. In one embodiment, the bias capping structure may comprise a multiple layered structure comprising one or combination of a tantalum layer, an iridium layer, a chromium layer, a titanium layer and a ruthenium layer.

As shown in FIG. 3A-3D, the top surface of the first insulating layer 318, the top surface of the bias layer 320 and the top surface of the free magnetic layer 316 are all collinear. A spin Hall effect layer 322 is deposited over the sensor structure 302. The spin Hall effect layer 322 comprises heavy metals such as Pt, Ta, W or combinations thereof. In one embodiment, the spin Hall effect layer 322 comprises copper doped with bismuth or iridium. The spin Hall effect layer 322 may comprise a noble metal having group 5d non-magnetic impurities. The spin Hall effect layer 322 comprises a material with a lower resistivity than the top shield S2, side shield (if present) or lead layer (if present) to maximize the current density flowing through the spin Hall effect layer 322.

The spin Hall effect arises from spin orbit interaction of conduction electrons in normal metals. When the electric current density j_{C} is applied in an x direction through a conducting layer of thickness t along the z-direction, the spin current j_{S} of y-polarized spins flows in the z direction, i.e., across the layer thickness. If there is a ferromagnetic layer on the conducting layer, the spin current can affect the ferromagnetic layer's static and dynamic magnetic properties via spin transfer torque and/or spin pumping effects. Hence, in the embodiment shown in FIG. 3A, the spin Hall effect layer 322 can permit current applied to the top shield S2 to pass through the spin Hall effect layer 322 and generate spin current along its thickness that would interact with free magnetic layer 316 as to reduce damping of the free magnetic layer 316.

In the embodiment shown in FIG. 3A, current is applied to the top shield S2 from a power source 324. The current is applied in the longitudinal direction which forces the longitudinal current through the spin Hall effect layer 322 that is in contact with the free magnetic layer 316. The polarity of the longitudinal bias current is chosen to reduce the damping of the free magnetic layer 316.

A second insulating layer 326 is disposed over the bias layer 320 and the first insulating layer 318. The second insulating layer 326 may be deposited by well known deposition methods such as ALD, CVD, and IBD. In the embodiment shown in FIG. 3A, the second insulating layer 326 has a top surface that is collinear with the top surface of the spin Hall effect layer 322.

In the embodiment shown in FIG. 3B, the second insulating layer 326 is thinner than the spin Hall effect layer 322 and hence, the top surface of the second insulating layer 326 and the spin Hall effect layer 322 are not collinear. However, the bias layer 320, first insulating layer 318 and free magnetic layer 316 of the sensor structure 302 have top surfaces that are collinear. The thinner second insulating layer 326 shown in FIG. 3B forces a higher current density through the spin Hall effect layer 322, thus maximizing spin current generated by the spin Hall effect and the reduction of damping in free magnetic layer 316.

In the embodiment shown in FIG. 3C, a spin Hall effect spacer layer 328, which increases efficiency of damping reduction, is disposed between the spin Hall effect layer 322 and the free magnetic layer 316. The top surface of the second insulating layer 326 is not collinear with either the spin Hall effect layer 322 or the spin Hall effect spacer layer 328. However, the bias layer 320, first insulating layer 318 and free magnetic layer 316 of the sensor structure 302 have top surfaces that are collinear. It is contemplated that the top surface of the second insulating layer 326 may be collinear with the top surface of the spin Hall effect layer 322.

In the embodiment shown in FIG. 3D, a laminated shield S2 is comprised of first shield layer LS1, third insulating layer 322 and second shield layer LS2. The first shield layer LS1 is disposed over the second insulating layer 326 and the spin Hall effect layer 322. The first shield layer LS1 is coupled to the power source 324 and may comprise a soft magnetic material with high permeability such as NiFe. A third insulating layer 332 can propagate the interlayer exchange coupling and is disposed on the first shield layer LS1. The third insulating layer 332 may be deposited by well known deposition methods such as ALD, CVD, and IBD. In the embodiment shown in FIG. 3D, the second insulating layer 326 has a top surface that is not collinear with the top surface of the spin Hall effect layer 322. However is it contemplated that the second insulating layer 326 top surface may be collinear with the top surface of the spin Hall effect layer 322. The bias layer 320, first insulating layer 318 and free magnetic layer 316 of the sensor structure 302 have top surfaces that are collinear. The second shield layer LS2 that completes laminated shield S2 is deposited on the third insulating layer 332. The second shield layer LS2 may also comprise a soft magnetic material with high permeability such as NiFe. The third insulating layer 332 forces the longitudinal current to pass through the spin Hall effect layer 322 thus maximizing spin current generated by the spin Hall effect and the reduction of damping in free magnetic layer 316.

FIG. 3E is an embodiment employing a side shield 334 rather than a bias layer 320. As shown in FIG. 3E, the side shield 334 is disposed on the first insulating layer 318 and the second insulating layer 326 that can propagate the interlayer exchange coupling is disposed on the side shield 334. The side shield 334 is coupled to the power source 324 and the side shield 334 is disposed on the spin Hall effect layer 322. Suitable materials that may be used for the side shield 334 include Co, Fe, B, Co, CoFe, CoFeB, NiFe, CoHf or combinations thereof.

As shown in FIG. 3E, the first insulating layer 318 top surface is collinear with the top surface of the free magnetic layer 316. The first insulating layer 318 can be adjusted in height to enable the maximum current density to flow through the spin Hall effect layer 322. In other words, the first insulating layer 318 top surface need not be collinear with the top surface of the free magnetic layer 316.

By applying a bias to a shield layer that is in contact with a spin Hall effect layer, the damping of the free magnetic layer is reduced as is the magnetic noise. As such, the magnetic read head has an increased signal to noise ratio due to the reduced magnetic noise.

While the foregoing is directed to exemplary embodiments, other and further embodiments of the invention may be devised without departing from the basic scope thereof, and the scope thereof is determined by the claims that follow.

What is claimed is:

1. A magnetic read head, comprising:
a magnetic sensor having a free magnetic layer; and
a spin Hall effect layer disposed over the free magnetic layer.

2. The magnetic read head of claim 1, further comprising a spin Hall effect spacer layer disposed between the spin Hall effect layer and the free magnetic layer.

3. The magnetic read head of claim 1, wherein the spin Hall effect layer comprises Pt, Ta, W, copper doped with bismuth or iridium, a noble metal having group 5d non-magnetic impurities, or combinations thereof.

4. The magnetic read head of claim 1, wherein the spin Hall effect layer has a lower resistivity than a shield disposed over the spin Hall effect layer.

5. The magnetic read head of claim 1, further comprising a shield disposed on the spin Hall effect layer, wherein the shield is electrically coupled to a power source.

6. The magnetic read head of claim 5, further comprising:
a first insulating layer disposed on sidewalls of the free magnetic layer and sidewalls of the spin Hall effect layer.

7. The magnetic read head of claim 6, further comprising
a hard bias layer disposed on the first insulating layer, wherein the hard bias layer has a top surface that is substantially collinear with a top surface of the free magnetic layer.

8. The magnetic read head of claim 7, further comprising:
a second insulating layer disposed on the hard bias layer, wherein the second insulating layer has a top surface that is collinear with a top surface of the spin Hall effect layer.

9. The magnetic read head of claim 6, further comprising:
a soft bias layer disposed on the first insulating layer, wherein the soft bias layer has a top surface that is substantially collinear with a top surface of the free magnetic layer.

10. The magnetic read head of claim 9, further comprising:
a second insulating layer disposed on the soft bias layer, wherein the second insulating layer has a top surface that is collinear with a top surface of the spin Hall effect layer.

11. The magnetic read head of claim 5, further comprising:
an insulating layer that can propagate interlayer exchange coupling disposed on the first shield layer; and
a second shield layer disposed on the insulating layer.

12. A magnetic read head, comprising:
a bottom shield;
a pinned magnetic structure disposed over the bottom shield;
a spacer layer disposed on the pinned magnetic structure;
a free magnetic layer disposed on the spacer layer;
a spin Hall effect layer disposed on the free magnetic layer;
a first insulating layer disposed on the bottom shield, sidewalls of the pinned magnetic structure, sidewalls of the spacer layer, sidewalls of the free magnetic layer, and sidewalls of the spin Hall effect layer;
a hard bias layer disposed on the first insulating layer, wherein the hard bias layer has a top surface that is collinear with a top surface of thee free magnetic layer;
a second insulating layer disposed on the hard bias layer, wherein the second insulating layer has a top surface that is collinear with a top surface of the spin Hall effect layer; and
a top shield disposed on the second insulating layer and the spin Hall effect layer, wherein the top shield is electrically coupled to a power source.

13. The magnetic read head of claim 12, wherein the spin Hall effect layer comprises Pt, Ta, W, copper doped with bismuth or iridium, a noble metal having group 5d non-magnetic impurities, or combinations thereof.

14. A magnetic read head, comprising:
a bottom shield;
a pinned magnetic structure disposed over the bottom shield;
a spacer layer disposed on the pinned magnetic structure;
a free magnetic layer disposed on the spacer layer;
a spin Hall effect layer disposed on the free magnetic layer;
a first insulating layer disposed on the bottom shield, sidewalls of the pinned magnetic structure, sidewalls of the spacer layer, sidewalls of the free magnetic layer, and sidewalls of the spin Hall effect layer;
a hard bias layer disposed on the first insulating layer, wherein the hard bias layer has a top surface that is collinear with a top surface of the free magnetic layer;
a second insulating layer disposed on the hard bias layer, wherein the second insulating layer is thinner than the spin Hall effect layer; and
a top shield disposed on the second insulating layer and the spin Hall effect layer, wherein the top shield is electrically coupled to a power source.

15. The magnetic read head of claim 14, wherein the spin Hall effect layer comprises Pt, Ta, W, copper doped with bismuth or iridium, a noble metal having group 5d non-magnetic impurities, or combinations thereof.

16. A magnetic read head, comprising:
a bottom shield;
a pinned magnetic structure disposed over the bottom shield;
a spacer layer disposed on the pinned magnetic structure;
a free magnetic layer disposed on the spacer layer;
a spin Hall effect spacer layer disposed on the free magnetic layer;
a spin Hall effect layer disposed on the spin Hall effect spacer layer;
a first insulating layer disposed on the bottom shield, sidewalls of the pinned magnetic structure, sidewalls of the spacer layer, sidewalls of the free magnetic layer, and sidewalls of the spin Hall effect layer;
a hard bias layer disposed on the first insulating layer, wherein the hard bias layer has a top surface that is collinear with a top surface of thee free magnetic layer;
a second insulating layer disposed on the hard bias layer, wherein the second insulating layer is thinner than the spin Hall effect layer; and
a top shield disposed on the second insulating layer and the spin Hall effect layer, wherein the top shield is electrically coupled to a power source.

17. The magnetic read head of claim 16, wherein the spin Hall effect layer comprises Pt, Ta, W, copper doped with bismuth or iridium, a noble metal having group 5d non-magnetic impurities, or combinations thereof.

18. The magnetic read head of claim 16, wherein the spin Hall effect spacer layer comprises copper or silver.

19. A magnetic read head, comprising:
a bottom shield;
a pinned magnetic structure disposed over the bottom shield;
a spacer layer disposed on the pinned magnetic structure;
a free magnetic layer disposed on the spacer layer;
a spin Hall effect layer disposed on the free magnetic layer;
a first insulating layer disposed on the bottom shield, sidewalls of the pinned magnetic structure, sidewalls of the spacer layer, sidewalls of the free magnetic layer, and sidewalls of the spin Hall effect layer;
a hard bias layer disposed on the first insulating layer, wherein the hard bias layer has a top surface that is collinear with a top surface of thee free magnetic layer;
a second insulating layer disposed on the hard bias layer, wherein the second insulating layer is thinner than the spin Hall effect layer;
a first shield layer disposed on the second insulating layer and the spin Hall effect layer, wherein the lead layer is electrically coupled to a power source;
a third insulating layer that can propagate interlayer exchange coupling disposed on the first shield layer; and
a second shield layer disposed on the third insulating layer.

20. The magnetic read head of claim 19, wherein the spin Hall effect layer comprises Pt, Ta, W, copper doped with bismuth or iridium, a noble metal having group 5d non-magnetic impurities, or combinations thereof.

21. A magnetic read head, comprising:
a bottom shield;
a pinned magnetic structure disposed over the bottom shield;
a spacer layer disposed on the pinned magnetic structure;
a free magnetic layer disposed on the spacer layer;
a spin Hall effect layer disposed on the free magnetic layer;
a first insulating layer disposed on the bottom shield, sidewalls of the pinned magnetic structure, sidewalls of the spacer layer, sidewalls of the free magnetic layer, and sidewalls of the spin Hall effect layer;
a side shield disposed on the first insulating layer and the spin Hall effect layer, wherein the side shield is electrically coupled to a power source;
a second insulating layer that can propagate interlayer exchange coupling disposed on the side shield; and
a top shield disposed on the second insulating layer.

22. The magnetic read head of claim 21, wherein the spin Hall effect layer comprises Pt, Ta, W, copper doped with bismuth or iridium, a noble metal having group 5d non-magnetic impurities, or combinations thereof.
